(19) United States
(12) Patent Application Publication
(10) Pub. No.: US 2020/0324442 A1
(43) Pub. Date: Oct. 15, 2020

(54) METHODS FOR PRODUCING GAS-INFUSED, LIGHTWEIGHT OVERMOLDING SOLUTION FOR CARBON FIBER PARTS

(71) Applicant: DELL PRODUCTS L.P., Round Rock, TX (US)

(72) Inventors: David W. WILLIAMS, Salado, TX (US); Xin Hua TIAN, Shanghai (CN); Nicholas D. ABBATIELLO, Round Rock, TX (US)

(73) Assignee: DELL PRODUCTS L.P., Round Rock, TX (US)

(21) Appl. No.: 16/380,797

(22) Filed: Apr. 10, 2019

(51) Int. Cl. B29C 44/12; B32B 5/18; B29C 44/34

(52) U.S. Cl. CPC B29C 44/12; B32B 5/18; B29K 2307/04; B29C 44/3415; B32B 2457/00; B29C 44/3442

(57) ABSTRACT

Systems and methods for making a thermoplastic carbon fiber plate having a plastic overmold. The method includes: heating a mold; inserting a thermoplastic carbon fiber component into a mold; mixing a supercritical fluid with a plastic mixture to infuse bubbles into the plastic mixture and to thereby reduce the density of the plastic mixture that includes a resin and glass fiber; injecting the mixture of the supercritical fluid and the plastic mixture into the mold so that a plastic overmold is formed and bonded to the thermoplastic carbon fiber component; and cooling the thermoplastic carbon fiber component and the plastic overmold. The cooled plastic overmold includes a foam core having a lower density due to the gas bubbles and a skin layer having a higher concentration of the resin than the foam core and a reduced surface roughness due to the heated mold.

### A. TECHNICAL FIELD

The present invention relates to plastic overmolding; more particularly, to overmolding plastic material on thermoplastic carbon fiber parts.

### B. DESCRIPTION OF THE RELATED ART

Weight reduction is a focus effort for various computing device. In particular, components included in portable computing devices, such as laptops, notebooks, and tablet form factors, are the object of efforts to reduce weight and thickness, without compromising structural strength. Both consumer and commercial marketing/customers are looking for lighter weight options while the surfaces of the components have the high-quality texture and cosmetic appearance. Generation over generation, the opportunity to reduce weight through material optimization is approaching an asymptote, and it has now come down to finding grams where further weight reduction can occur.

For instance, a typical overmolded LCD cover weights 175-180 grams depending on the size and overmolding design, and approximately 25% of the total part weight is coming from the 50% glass fiber resin overmolding. The 50% glass fiber material is used to reduce shrinkage of the core carbon fiber plate when the overmold on the carbon fiber plate is cooling. Lower shrinkage results in lower stress, which in turn results in less deformation of the LCD cover, where the lower deformation is required for both appearance and mechanical reasons. The downside of using highly glass-filled material is the high density associated with the glass fiber.

As such, there is a need for systems and methods for reducing the weight further without compromising the structural strength and cosmetic appearance.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may be not to scale.

FIG. 1 depicts a schematic diagram of an injection molding machine, according to embodiments of the present disclosure.

FIG. 2 depicts an exemplary component having a plastic overmold, according to embodiments of the present disclosure.

FIG. 3 depicts a flowchart of an illustrative overmolding process, according to embodiments of the present disclosure.

FIG. 4 depicts a cross sectional view of a plastic overmold, according to embodiments of the present disclosure.

FIG. 5 depicts a cross sectional view of a plastic overmold, according to embodiments of the present disclosure.

FIG. 6 depicts an exemplary component having a plastic overmold, according to embodiments of the present disclosure.

FIG. 7 depicts a comparison of two plastic overmolds, according to embodiments of the present disclosure.

FIG. 8 depicts composition ratio tables of exemplary components having plastic overmolds, according to embodiments of the present disclosure.

### DETAILED DESCRIPTION OF THE PREFERRED EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any lists the follow are examples and not meant to be limited to the listed items. It shall be noted that while embodiments are described in terms of using thermoplastic carbon fiber core, other cores may also be used.

It shall be noted that: (1) certain steps may optionally be performed; (2) steps may not be limited to the specific order set forth herein; (3) certain steps may be performed in different orders; and (4) certain steps may be done concurrently.

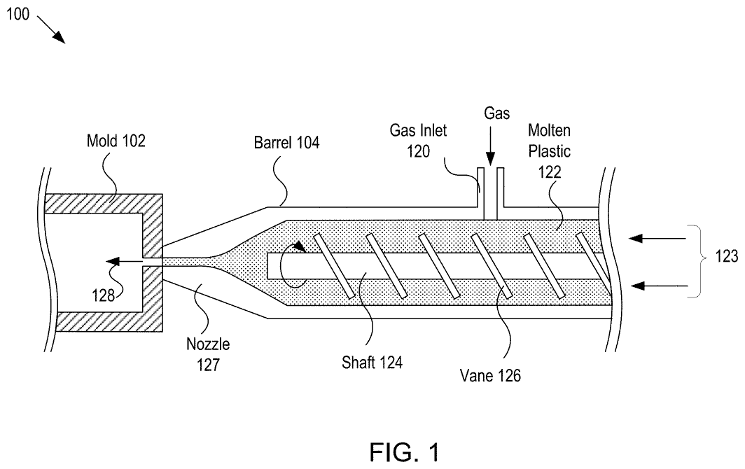

FIG. 1 depicts a schematic diagram of an injection molding machine according to embodiments of the present disclosure. As depicted, the injection molding machine 100 may include: a plasticizing barrel (or shortly barrel) 104 for housing various components of the molding machine; a shaft 124 having a plurality of disk-shaped vanes 126 fixed to the shaft; and a mold 102 having a cavity, where a substrate is partially or fully covered by an overmold material that is injected into the cavity through a nozzle 127 of the barrel, as indicated by an arrow 128.

In embodiments, the barrel 104 may include an inlet (not shown in FIG. 1) through which solid parent material is introduced. For the purpose of illustration, the parent material is assumed to be glass-filled plastic (or glass-filled resin), even though other types of material may be used as the parent material. The solid parent material may be heated into molten state in the barrel and the molten glass-filled plastic (or shortly molten plastic) 122 may be moved along the axial direction of the barrel, as indicated by the arrows 123, by the plurality of vanes 126 as the shaft 124 rotates. In embodiments, the molten glass-filled plastic may include thermoplastic resin and glass fiber and be used an overmolding material.

In embodiments, the barrel 104 may include a fluid inlet 120 for receiving a supercritical fluid, such as gas at its supercritical state, and the supercritical fluid may be mixed with the flowing stream of molten plastic in the barrel. The supercritical fluid may be used as the foaming agent in the glass-filled plastic, i.e., the supercritical fluid may generate gas bubbles within the molten plastic. In embodiments, the supercritical fluid may be made from inert gas, such as nitrogen or CO₂.

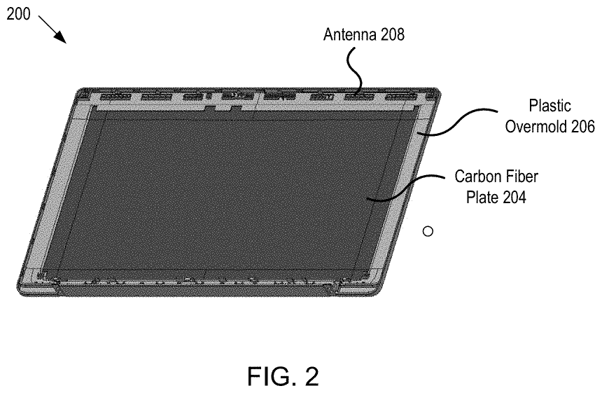

FIG. 2 depicts an exemplary component (part) 200 having a plastic overmold according to embodiments of the present disclosure. As depicted, the component 200 may include a carbon fiber plate 204 and a plastic overmold 206 covering a portion of the carbon fiber plate. In embodiments, the molding machine 100 may be used to form the plastic overmold 206 on the carbon fiber plate 204. For instance, the carbon fiber plate 204 may be located inside the cavity of the mold 102 and the molten plastic 122 may be injected into the cavity of the mold 102. In embodiments, various components, such as antenna 208, may be attached to the plastic overmold 206. It is noted that the carbon fiber plate 204 and the plastic overmold 206 may have other suitable shapes and applications.

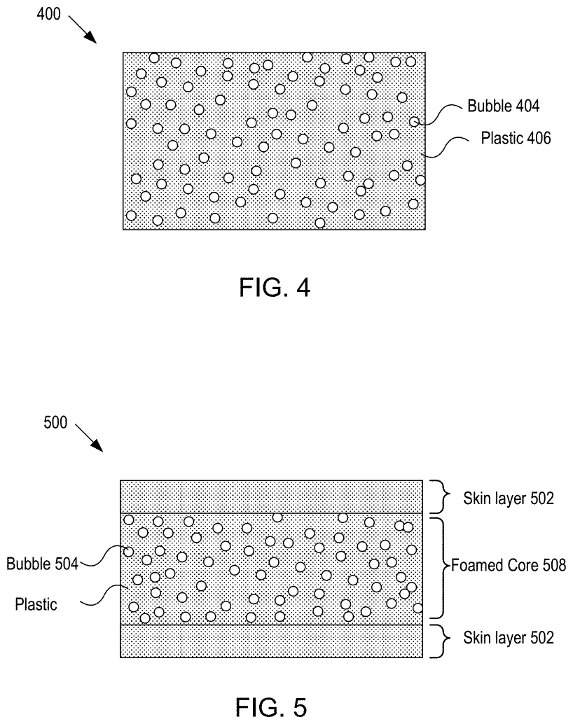

In embodiments, the carbon fiber plate 204 may be formed of thermoplastic carbon fiber (or shortly carbon fiber) material. In embodiments, the plastic mold 206 may include thermoplastic resin and glass fiber material. In embodiments, to reduce the weight of the component 200, the density of the plastic mold 206 may be reduced by injecting the supercritical fluid into the molten plastic in the barrel 104. As described in conjunction with FIG. 1, the supercritical fluid, such as nitrogen and CO₂ at the supercritical state, may be injected into the barrel 104 and mixed with the molten plastic 122. In embodiments, when the supercritical fluid is mixed with the molten plastic, the gas bubbles may be infused into the molten plastic, causing the molten plastic to be foamed when the molten plastic is cooled. FIG. 4 shows a cross sectional view of a plastic overmold 400 according to embodiments of the present disclosure. As depicted, when the supercritical fluid is mixed with the molten plastic, the gas bubbles 404 may be infused into the plastic 406 and replace the resin and glass fiber material, reducing the density (and the weight) of the plastic overmold.

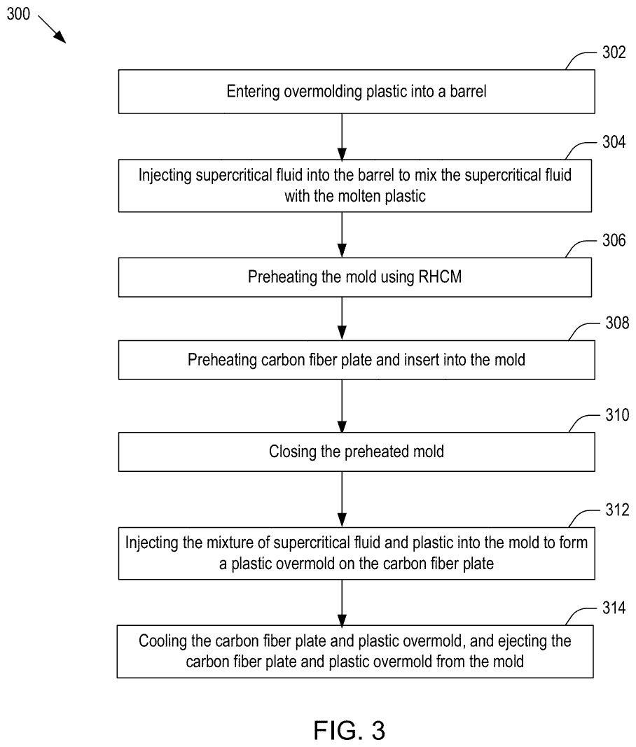

FIG. 3 depicts a flowchart 300 of an illustrative overmolding process according to embodiments of the present disclosure. The process starts at step 302. At step 302, the parent plastic may be entered into the barrel 104 of the molding machine 100. In embodiments, the entered parent plastic may be in the form of grain or powder, and the entered parent plastic may be heated into molten state in the barrel and moved along the axial direction of the barrel. At step 304, the supercritical fluid, such as nitrogen and/or CO₂ at the supercritical state, may be injected into the barrel through the gas inlet 120 and mixed with the molten plastic 122 in the barrel.

As discussed above in conjunction with FIG. 4, the gas bubbles may be infused into the molten plastic and, when the molten plastic is cooled, the molten plastic may have a core that looks like a hard microcellular foam. The surface of the microcellular foam type core (or shortly foamed core) may not have a good cosmetic appearance due to the surface irregularity caused by the bubbles and the glass fiber material included in the plastic. In embodiments, to reduce the surface roughness, the inner surface of the mold 102 may be heated before the molten plastic 122 is injected into the mold. In embodiments, when the mixture of the supercritical fluid and molten plastic is injected into the preheated mold, the surfaces of the plastic overmold may have a resin rich structure, i.e., the core may be buried under a resin rich layer that gives enhanced cosmetic appearance. FIG. 5 depicts a cross sectional view of a plastic overmold 500 according to embodiments of the present disclosure. As depicted, the outer layers (or equivalently skin layers) 502 may be resin rich layers and cover the inner core 508, where the plastic mold 500 may be generated by preheating the mold 102 before the mixture of the molten plastic 122 and supercritical fluid is injected into the cavity of the mold 102. In embodiments, the skin layers 502 may have the lower number density of the gas bubbles 504 than the core 508, and the composition ratio (i.e. concentration) of the resin is higher in the skin layer than that in the core 508.

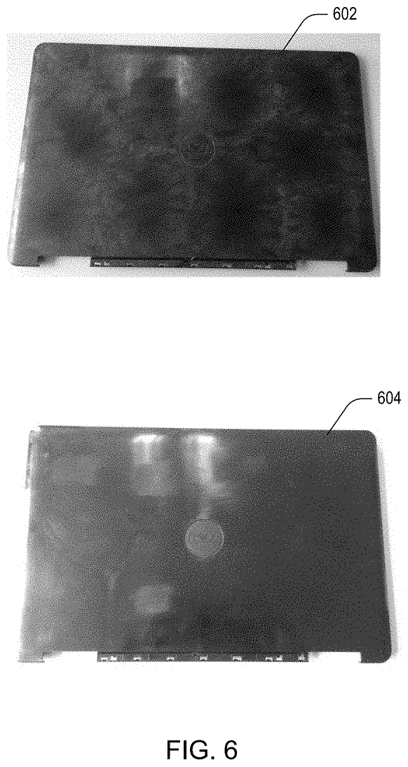

FIG. 6 depicts a comparison of two plastic overmolds according to embodiments of the present disclosure. As depicted, both of the plastic overmolds 602 and 604 are generated by mixing the supercritical fluid with the molten plastic in the barrel 104. The difference is that the plastic overmold 602 is generated without preheating the mold 102, while the plastic overmold 604 is generated with preheating the mold. As depicted, the plastic overmold 604 has enhanced cosmetic appearance (e.g., smoother appearance and smoother surface texture) than the plastic overmold 602 due to the resin rich skin layers.

Now referring back to FIG. 3, at step 306, the mold 102 may be preheated using a rapid heat cycle molding (RHCM) technique so that the plastic overmold may have resin rich skin layers. It is noted that other suitable types of heating techniques may be used to preheat the mold 102. At 308, the thermoplastic carbon fiber plate (or shortly carbon fiber plate) 204 may be preheated and inserted into the cavity of the mold 102, enhancing the bonding of the molten plastic to the surface of the carbon fiber plate better.

Then, the heated mold 102 may be closed and the mixture of molten plastic and supercritical fluid may be injected into the cavity of the mold 102 to form a plastic overmold 206 on the carbon fiber plate 204 at steps 310 and 312. At step 314, the carbon fiber plate 204 and plastic overmold 206 may be cooled in the mold 102 and ejected from the mold 102.

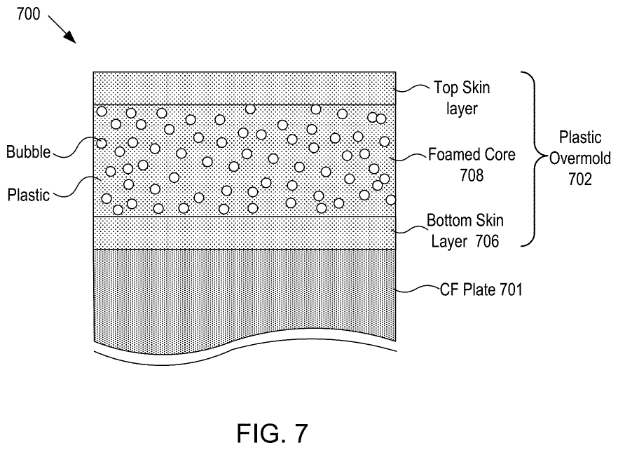

FIG. 7 depicts an exemplary component having a plastic overmold according to embodiments of the present disclosure. As depicted, the component 700 may include: a carbon fiber (CF) plate 701; and a plastic overmold 702 disposed on the CF plate. In embodiments, the plastic overmold 702 may have a similar structure as the plastic overmold 500, with the difference that the plastic overmold 702 may be formed on the CF plate 701. As discussed above in conjunction with step 308, the CF plate 701 may be preheated and inserted into the cavity before the molten plastic is injected into the mold. In such a case, the bottom skin layer 706, which has the lower number density of bubbles than the foamed core 708, may be formed, enhancing the bonding of the plastic mold 702 to the CF plate 701.

During step 314, the plastic overmold 206 may shrink as the temperature inside the mold 102 goes down and pull the carbon fiber plate 204 to warp (deform), which may give negative impact on the surface flatness of the carbon fiber plate. Since the plastic overmold having the foam core causes lower deformation than a plastic overmold having a solid plastic core and since the glass fiber is used to prevent shrinkage during the cooling process, the plastic overmold 206 may have a reduced composition ratio of the glass fiber material without compromising the deformation (warpage) of the carbon fiber plate 204. (Hereinafter, the term solid plastic refers to a plastic having a non-porous structure.) Stated differently, the composition ratio of the glass fiber material in the plastic overmold may be set to a minimum threshold to prevent a deformation (warpage) of the carbon fiber plate, and the foamed core may allow the minimum threshold to be lowered. Also, since the glass fiber material is heavier than the resin, the reduced composition ratio of the glass fiber may further lower the weight of the plastic overmold 206.

In general, the glass fiber material may have negative effect on the cosmetic appearance of the plastic overmold 206. Also, the plastic overmold 206 may become more brittle as the composition ratio of the glass fiber material increases. Thus, in embodiments, by mixing the supercritical fluid with the molten plastic at step 304, the plastic overmold 206 may have enhanced cosmetic appearance and ductility, in part by being able to reduce the glass fiber percentage.

In embodiments, the molding machine 100 may inject the mixture of supercritical fluid and molten plastic 122 into the cavity of the mold 102 at a preset injection pressure, where the injection pressure for the mixture may be lower than the injection pressure for a solid molten plastic. In embodiments, since the injection pressure may be lowered, the stress caused by the molten plastic during the cooling stage may be reduced, allowing further reduction in the composition ratio of the glass fiber material.

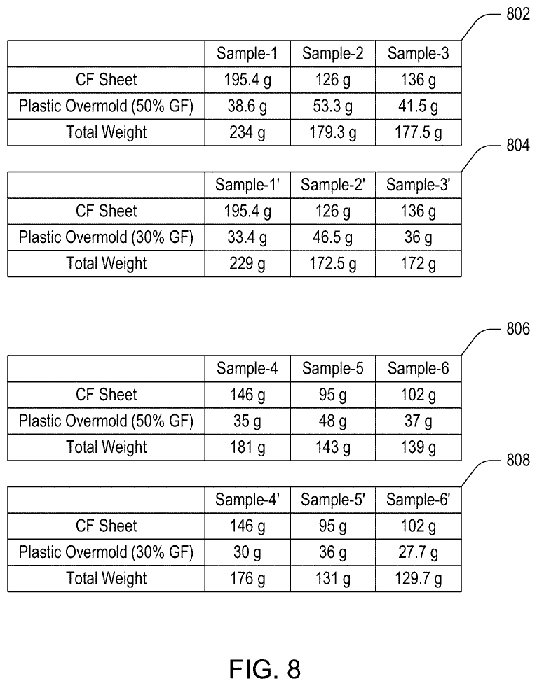

In embodiments, a composition ratio of the glass fiber in the plastic mixture may be set to a minimum threshold that prevents a deformation of the thermoplastic carbon fiber component from reaching a preset limit during the step 314. FIG. 8 depicts composition ratio tables of exemplary components having plastic overmolds according to embodiments of the present disclosure. Table 802 shows weights of carbon fiber (CF) sheets and plastic overmolds for three samples, sample-1, sample-2, and sample-3, where the composition ratio of glass fiber in the plastic overmolds is 50% by weight. Table 804 shows weights of carbon fiber (CF) sheets and plastic overmolds for three samples, sample-1′, sample-2′, and sample-3′, where the composition ratio of glass fiber in the plastic overmolds is 30% by weight. In embodiments, the plastic overmolds of the three samples in Table 804 may be made of a mixture of supercritical fluid and molten plastic, as discussed in conjunction with FIG. 3. As shown in Tables 802 and 804, the samples in Table 804 may have reduced total weight due to the beneficial effects of the supercritical fluid while the structural strength and cosmetic appearance are not compromised. For instance, sample-1 has the total weight of 234 gram while sample-1′ has the total weight of 229 grams. As such, for sample-1, the supercritical fluid results in the weight reduction by 5 grams.

Table 806 shows weights of carbon fiber (CF) sheets and plastic overmolds for three samples, sample-4, sample-5, and sample-6, where the composition ratio of glass fiber in the plastic overmolds is 50% by weight. Table 808 shows weights of carbon fiber (CF) sheets and plastic overmolds for three samples, sample-4′, sample-5′, and sample-6′, where the composition ratio of glass fiber in the plastic overmolds is 30% by weight. In embodiments, the plastic overmolds of the three samples in Table 808 may be made of a mixture of supercritical fluid and molten plastic as discussed in conjunction with FIG. 3. As shown in Tables 806 and 808, the samples in Table 808 may have reduced total weight due to the beneficial effects of the supercritical fluid while the structural strength and cosmetic appearance are not compromised. For instance, sample-5 has the total weight of 143 grams while sample-5′ has the total weight of 131 grams. As such, for sample-5, the supercritical fluid results in the weight reduction by 12 grams.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A component having a plastic overmold and prepared by a process comprising the steps of:
heating a mold;
inserting a thermoplastic carbon fiber component into a mold;
mixing a supercritical fluid with a plastic mixture to infuse a plurality of gas bubbles into the plastic mixture and to thereby reduce a density of the plastic mixture that comprises a resin and glass fiber;
injecting the mixture of the supercritical fluid and the plastic mixture into the mold so that a plastic overmold is formed and bonded to the thermoplastic carbon fiber component; and
cooling the thermoplastic carbon fiber component and the plastic overmold, wherein the cooled plastic overmold comprises a foam core having a reduced density due to the plurality of gas bubbles and a skin layer having a higher concentration of the resin than the foam core and a reduced surface roughness due to the heated mold.

2. A component as recited in claim 1, further comprising, prior to the step of injecting a mixture:
prior to the step of inserting the thermoplastic carbon fiber component into the mold, heating the carbon fiber component to enhance a bonding of the plastic mold to the thermoplastic carbon finer component.

3. A component as recited in claim 2, further comprising:
ejecting the cooled thermoplastic carbon fiber component and the plastic overmold from the mold.

4. A component as recited in claim 1, wherein the step of heating the mold is performed by a rapid heating and cooling molding (RHCM) technique.

5. A component as recited in claim 1, wherein the supercritical fluid comprises at least one of nitrogen and CO₂.

6. A component as recited in claim 1, wherein a composition ratio of the glass fiber in the plastic mixture is set to a minimum threshold that prevents a deformation of the thermoplastic carbon fiber component from reaching a limit during the step of cooling to thereby minimize a weight of the plastic mixture.

7. A component as recited in claim 6, wherein a composition ratio of the glass fiber in the plastic mixture is 30% by weight.

8. A component as recited in claim 1, wherein the step of injecting the mixture is performed at a pressure that is lower than a pressure for injecting the plastic mixture that is not mixed with the supercritical fluid into the mold.

9. A method for making a component having a plastic overmold, comprising:
heating a mold;
inserting a thermoplastic carbon fiber component into a mold;
mixing a supercritical fluid with a plastic mixture to infuse a plurality of gas bubbles into the plastic mixture and to thereby reduce a density of the plastic mixture that comprises a resin and glass fiber;
injecting the mixture of the supercritical fluid and the plastic mixture into the mold so that a plastic overmold is formed and bonded to the thermoplastic carbon fiber component; and
cooling the thermoplastic carbon fiber component and the plastic overmold, wherein the cooled plastic overmold comprises a foam core having a reduced density due to the plurality of gas bubbles and a skin layer having a higher concentration of the resin than the foam core and a reduced surface roughness due to the heated mold.

10. A method as recited in claim 9, further comprising:
prior to the step of inserting the thermoplastic carbon fiber component into the mold, heating the carbon fiber component to enhance a bonding of the plastic mold to the thermoplastic carbon finer component.

11. A method as recited in claim 9, further comprising:
ejecting the cooled thermoplastic carbon fiber component and the plastic overmold from the mold.

12. A method as recited in claim 9, wherein the step of heating the mold is performed by a rapid heating and cooling molding (RHCM) technique.

13. A method as recited in claim 9, wherein the supercritical fluid comprises at least one of nitrogen and CO₂.

14. A method as recited in claim 9, wherein a composition ratio of the glass fiber in the plastic mixture is set to a minimum threshold that prevents a deformation of the thermoplastic carbon fiber component from reaching a limit during the step of cooling to thereby minimize a weight of the plastic mixture.

15. A method as recited in claim 14, wherein the composition ratio of the glass fiber in the plastic mixture is 30% by weight.

16. A method as recited in claim 9, wherein the step of injecting the mixture is performed at a pressure that is lower than a pressure for injecting the plastic mixture that is not mixed with the supercritical fluid into the mold.

17. A thermoplastic carbon fiber component having a plastic overmold, comprising:
a thermoplastic carbon fiber component;
a plastic overmold bonded to the thermoplastic carbon fiber component, made of a mixture of a resin and glass fiber, and having a foam core that has a reduced density due to a plurality of gas bubbles infused into the mixture and a skin layer that has a higher concentration of the resin than the foam core and a lower surface roughness than the foam core.

18. A thermoplastic carbon fiber component as recited in claim 17, wherein the plurality of gas bubbles are formed of an inert gas.

19. A thermoplastic carbon fiber component as recited in claim 17, wherein a composition ratio of the glass fiber in the mixture is set to a minimum threshold that prevents a deformation of the thermoplastic carbon fiber component from reaching a limit to thereby minimize a weight of the mixture.

20. A thermoplastic carbon fiber component as recited in claim 19, wherein the composition ratio of the glass fiber in the mixture is 30% by weight.
